(19) United States
(12) Patent Application Publication
(10) Pub. No.: US 2008/0276310 A1
(43) Pub. Date: Nov. 6, 2008

(54) Network Security System

(75) Inventors: Delon Dotson, Redding, CT (US); Marc Loy, Cincinnati, OH (US)

Correspondence Address: MOORE & VAN ALLEN PLLC, P.O. BOX 13706, Research Triangle Park, NC, 27709, US

(73) Assignee: Palm Tree Technology IP Limited, London (GB)

(21) Appl. No.: 11/911,689

(22) PCT Filed: Mar. 27, 2006
(86) PCT No.: PCT/EP06/03072

§ 371 Date: Jul. 2, 2008

(30) Foreign Application Priority Data
Apr. 21, 2005 (GB) 0508044.5

(51) Int. Cl. H04L 9/32

(52) U.S. Cl. 726/9

(57) ABSTRACT

A method of authenticating a transaction between a local device under control of a user and a remote server, comprising: determining a series of data specific to the local device; —determining a series of data specific to the user of the device; —transmitting the device specific data series and the user specific data series to a remote encryption engine; —generating at the remote encryption engine a series of unique, single-use data templates, each template comprising randomly selected items from the device specific data series and the user specific data series; the method further comprising, during authentication: —sending a data template from the engine to the local device; —using the data template to interrogate the local device for the device specific data items in the template; —using the data template to interrogate the user to provide the user specific data items in the template; and —comparing the data items provided by the local device and the user in response to interrogation to the data items used to create the template to authenticate the transaction.

### TECHNICAL FIELD

The present invention relates to security systems for operation with networked devices. In particular, the invention provides methods and systems for assuring the identity of a user in a networked transaction environment.

### BACKGROUND ART

An environment in which this invention finds particular application is that of secure transactions over the internet. However, as will be apparent, the invention is not restricted to such uses and may be applied to transactions between devices using various means of communication.

Various methods have been developed to provide security in internet transactions. One example of these is the Secured Socket Layers (SSL) developed by Netscape as a security protocol for single transactions. This can be used for one-off events such as a credit card payment for a purchase made via an internet site. However, most transactions are not single event and a further level of security is required. The most common of these is the use of access codes, pin numbers or passwords. These usually require that a user inputs a “secret” code to confirm identity of the user and create a “secure” communication channel between the user and the service provider such as the bank. As long as the code remains secret, the communication can be secure. However, it can be relatively easy to determine the secret code, either by interrogating the computer on which the code is saved, logging keyboard strokes when the code is entered, observing code entry or a written record of the code, or by simple trial and error based on mathematical analysis. Some systems attempt to improve the level of security by combinations of codes and selected questions that relate to personal information of the user. However, these are still subject to the same general weaknesses.

An improved level of security can be obtained using a smart card (a card carrying an IC chip). The limited processing on the card chip allows more complex encryption to be used. Also, it provides a physical key that must be present along with the relevant code. There are practical considerations that make the use of such cards less desirable. The user's computer must be able to read the card, the cards are relatively expensive, and the cards need a secure manner of issue and distribution.

All of these systems rely on user information only. This invention makes use of device-specific information to improve the level of security.

### DISCLOSURE OF THE INVENTION

One aspect of the invention comprises a method of authenticating a transaction between a local device under control of a user and a remote server, comprising:
determining a series of data specific to the local device;
determining a series of data specific to the user of the device;
transmitting the device specific data series and the user specific data series to a remote encryption engine;
generating at the remote encryption engine a series of unique, single-use data templates, each template comprising randomly selected items from the device specific data series and the user specific data series;

the method further comprising, during authentication:
sending a data template from the engine to the local device;
using the data template to interrogate the local device for the device specific data items in the template;
using the data template to interrogate the user to provide the user specific data items in the template; and
comparing the data items provided by the local device and the user in response to interrogation to the data items used to create the template to authenticate the transaction.

Preferably, the method includes the step of loading a software agent onto the local device, the software agent handling determination of the device specific data, providing an interface for the user to enter the user-specific data, and communication of these data in encrypted form to the encryption engine.

It is also preferred that, following use of the data template in an authentication operation, that template is deleted from the series.

In one embodiment of the invention, the data template is sent to the local device immediately before the transaction to be authenticated, and the response is sent from the local device to the remote server following receipt and before the transaction takes place.

The local device can be a computer, a mobile phone, a PDA or any other such device. The local device can connect to the remote server via a suitable communications channel such as the internet, wireless connection, GPRS, WAN, LAN, etc.

The data specific to the local device can comprise data relating to the physical configuration of the device such as id numbers for components such as hard drives, CPUs etc., and software and firmware configuration such as OS type and version, BIOS version, etc.

The data specific to the user typically comprise information known to the user and provided in response to

### MODE(S) FOR CARRYING OUT THE INVENTION

The following aspect of the invention is described in relation to a computer as a local device. It will be apparent that the same methodology can apply to many different types of device such as telephones, mobile phones, PDAs, etc.

Every computer has certain properties which are unique to that machine. These include identification numbers or registration numbers of the CPU, motherboard or hard drives, for example. Other information contained within the machine can include hard drive size, RAM storage capacity, date of purchase or registration, BIOS release, operating system, machine name, etc. These data are typically stored on the machine hard disk (or equivalent). While few of these data items are absolutely unique, except possibly the identification or registration numbers, there are sufficient different data items and variation between these elements in apparently identical computers that the likelihood of any computer having identical data is very low. However, on their own, these data are not absolutely secure. If a computer is connected to a network, it is relatively straightforward to interrogate the machine to provide these data and mimic this machine.

To avoid this problem, the present invention also uses user-specific data. This is information provided by the user and known only to that user. Such information can comprises information such as date of birth, mother's maiden name, etc. However, since this information can also be obtained from other sources, it is preferred that the user-specific data also includes information relating to personal preference such as favourite colour, or unusual personal information such as a pet name or the like. By providing sufficient items of such information, the likelihood of another user having the same personal information is very low.

These two sets of data form the basis of the invention. The object is to provide a system that requires information randomly selected from both sets to authenticate the transaction.

The invention relates to transaction between local devices and remote servers. Typical examples of such transactions are internet banking and internet shopping. In such transactions, a user uses the local device to communicate with the remote server to request information or instruct actions (e.g. view account balances, instruct purchases or transfers, etc.). Because of the value of the transaction, either in terms of personal information (names, addresses, account numbers, account balances, etc.), or direct commercial value (payments, etc.), it is desirable for both the user and the service provider to authenticate the transaction to confirm that the user is entitled to submit or receive the information or instruct the action. The basic approach to such authentication, both in the prior art and in the present invention, is that the remote server interrogates the user via the local device for data that confirms identity.

In the present invention, the manner in which the two data sets are used is by use of a an encryption engine. In a typical transaction, this will be the responsibility of the entity controlling the remote server. However, in many cases, the encryption engine will be on a separate server and will act in response to requests from the remote server.

In order to set up the local device, a software agent is installed on the local device. Such software agents are commonly used for various software applications. The software agent may be loaded via a network connection, CD or any other such approach. Once installed, the software agent interrogates the local device to obtain the device specific data. The types of data will be predetermined in the agent and may include those device specific data indicated above. The desired approach is that this interrogation and data selection should be automatic. It is possible that this could also be done manually through the use of dialogue boxes and data input fields. User specific data will be collected by use of dialogue boxes and data input fields, data being input in response to questions presented by the software agent. While pre-defined questions are preferred it is also envisaged that the user could also enter their own questions and answers.

The data collected by the software agent are transmitted to the encryption engine, via a network connection, typically in encrypted form. The encryption engine then mixes or “munges” (mung=Mash Until No Good) the two data sets and creates a series of single use data templates that are themselves stored in encrypted form. There are a number of known techniques and algorithms for munging data that may be used. All that is important is that following munging, the data is not recognisable as its original source data.

Each data template comprises a randomly selected combination of data items from each set: user specific and device specific. A number of these templates can be prepared in advance, for example 500 templates stored ready for use. It is also possible to create each template only when required with none being stored. However, this may slow the process unacceptably.

Each data template is intended to be used once only. In this respect, the set of data templates are similar to one-time pads used for ciphers.

In use, the user initiates a transaction with the server from the local device. At the point authentication is required, the authentication software application in the remote server requests that a template be issued by the encryption engine. Either the next template in the set is issued or a new template is generated by the engine. This template is sent to the server and to the local device. The software application in the remote server determines, from the data provided by the software agent in the local device, the specific data items required to authenticate the transaction from the template. The software agent in the local device interrogates the device for the device specific data and displays dialogue boxes and data entry fields for the user specific data. Once these data are entered, they are sent in encrypted form to the remote server where the software application compares the data provided from the local device with the data derived from the engine as correct to match that data template. If the data items are correct, the transaction can be authenticated. If not, the transaction can be denied.

The method of the present application has a number of advantages. These include the fact that intercepting the data transmitted from the local device to the server is of no use later since another template will require a different combination of data items. Also, changing a device parameter such as a disk drive can be accommodated by reregistering the device specific data following such an event and generating new templates.

Typical applications comprise online banking and internet shopping. However, a particular use of this method can be in the distribution of music via the internet. In such a use, the digital music file is delivered to the local device following authentication as described above. The device specific data are retained with the digital file and the player configured so that it only plays if the device on which the file is to be played can provide the required data to those in the file. Thus the music file can only be played on the device to which it was originally delivered. This allows the music rights owner to prevent unauthorised distribution of copies of the music file since they will be unplayable on any other device.

It will be appreciated that methods according to the invention are broadly applicable and are not limited to any one particular form of device or transaction. Software implementation of the concepts is straightforward.

1. A method of authenticating a transaction between a local device under control of a user and a remote server, comprising:
determining a series of data specific to the local device;
determining a series of data specific to the user of the device;
transmitting the device specific data series and the user specific data series to a remote encryption engine;
generating at the remote encryption engine a series of unique, single-use data templates, each template comprising randomly selected items from the device specific data series and the user specific data series;
the method further comprising, during authentication:
sending a data template from the engine to the local device;
using the data template to interrogate the local device for the device specific data items in the template;
using the data template to interrogate the user to provide the user specific data items in the template; and
comparing the data items provided by the local device and the user in response to interrogation to the data items used to create the template to authenticate the transaction.

2. A method as claimed in claim 1, wherein the user specific data and the device specific data are gathered by means of a software agent installed on the device.

3. A method as claimed in claim 1, wherein the encryption engine generates the series of templates that are stored prior to use.

4. A method as claimed in claim 1, wherein the encryption engine generates each template in response to a request for authentication from the remote server.

5. A method as claimed in claim 1, wherein the transaction comprises sending an executable file from the server to the device, the method further including associating device specific data with the executable file such that it can only be executed on that device.

6. A method as claimed in claim 1, wherein the transaction comprises providing information, online purchasing or downloading music.
